(19) United States
(12) Patent Application Publication
(10) Pub. No.: US 2007/0033536 A1
(43) Pub. Date: Feb. 8, 2007

(54) Time registration system

(76) Inventor: Ulrik Skovgaard Rasmussen, Kasmosevej (DK)

Correspondence Address: CANTOR COLBURN, LLP, 55 GRIFFIN ROAD SOUTH, BLOOMFIELD, CT, 06002, US

(21) Appl. No.: 10/547,133

(22) PCT Filed: Feb. 24, 2003
(86) PCT No.: PCT/DK03/00120

§ 371 Date: May 1, 2006

(51) Int. Cl. G06F 3/00; G06F 9/44

(52) U.S. Cl. 715/764; 705/7

(57) ABSTRACT

The present invention relates to a method of establishing a time registration comprising the steps of graphically presenting at least two sets of items (HL, VL), thereby establishing a set of nodes (NO), each node (NO) representing a combination of a specific item (IT) from a first of said sets of items (HL) and a specific item (IT) from a further of said sets of items (VL); and associating one of said nodes (NO) with at least one time reference.

### FIELD OF THE INVENTION

The present invention relates to a method of establishing a time registration as well as a time registration system.

### BACKGROUND OF THE INVENTION

Several different implementations of user interfaces and time registration methods within the technical field of establishment of one or more time registrations are known within the art.

Within the most simple of such systems the user is provided with a list of e.g. customers and the ability to manually associate time registrations with the individual items of that list. More widely used systems feature automatic registration of elapsed time by means of built-in timers and means for letting a user start and stop those.

More advanced systems enable the user to also associate a comment e.g. about the use of the registered time together with the time registration itself. Even more advanced systems comprise in addition to the above-mentioned first list of e.g. customers, a second list of e.g. tasks. For each registration the user is then enabled to choose a task from the second list instead of typing it in manually.

The most advanced systems commonly in use enable the user to set up a list of frequently used combinations of customers and tasks. New registrations are made on the basis of these in predefined customer-task combinations thereby sparing the user the trouble of manually adding e.g. a task or a comment to each registration.

The last of the above-described known systems feature significant advantages compared to the other systems by letting the user perform some otherwise frequently made actions e.g. selecting tasks to associate with a certain customer, once.

This advantage though often contributes to a major disadvantage of the system: As the number of customers increases, the list of combinations of customers and task increases too and thus gets confusing and difficult to use. The user might want to keep the list of combinations short and manageable by only adding combinations that are frequently used. But the shorter the list of predefined combinations is, the more often the user is obliged to manually establish a necessary combination before he or she is able to make a new registration. Furthermore, the addition of a new task that is going to be used with a lot of existing customers or a new costumer that is going to be combined with a lot of existing tasks requires a lot of new combinations to be manually defined.

It is one of the objects of the present invention to provide a system that more effectively, more user-friendly and more manageably enables the user to make a time registration.

### SUMMARY OF THE INVENTION

The present invention relates to a method of establishing a time registration comprising the steps of

graphically presenting at least two sets of items (HL, VL),

thereby establishing a set of nodes (NO),
each node (NO) representing a combination of
   a specific item (IT) from a first of said sets of items (HL) and
   a specific item (IT) from a further of said sets of items (VL); and
      associating one of said nodes (NO) with at least one time reference.

According to the present invention, each node in a set of nodes determines a combination of at least two items each from a different set of items. An item may e.g. be a word, a phrase, a number, a sentence, a symbol etc., or a combination of these possibly referring to e.g. a company, a customer, a task, a project, a resource, an employee, a machine, etc. Each set of items may comprise any, including zero, number of items. Each set preferably comprises items somehow associated with each other, e.g. one item set holds customers, a second holds task, etc. but any item may be comprised by any set of items within the scope of the invention. Two sets of items may be identical.

Examples of item combinations of potential relevance may e.g. be a certain customer combined with a certain project, a certain project combined with a certain task, a certain resource combined with a certain user, etc.

According to the present invention, a time reference may be any kind of time representing values, e.g. relative times, i.e. durations, absolute times, i.e. certain times at the day or certain times and days in the week or month, etc. A time reference may be derived from a clock with any accuracy or resolution.

Graphical presentation, according to the present invention, refer to any physical way of visually presenting an object, as well as any way of creating a visual impression of an object within the mind of a user. Thus, when e.g. lines having perpendicular directions are mentioned they may be actually presented physically in perpendicular directions, or they may be presented in such a way that the user gets the impression that they have perpendicular directions. Also when three-dimensional objects are mentioned they may be physically created as three-dimensional objects, e.g. by three-dimensional laser imaging methods, rapid prototyping, holography, etc. or they may be presented on a two-dimensional surface, e.g. a computer monitor, in a way that gives the user the impression of a three-dimensional object.

When said combination of a specific item (IT) from a first of said sets of items (HL) and a specific item (IT) from a further of said sets of items (VL) is further combined with at least one further specific item (IT) from at least one of said sets of items, a further advantageous embodiment of the present invention has been obtained.

According to this embodiment of the invention a node may determine a combination of more than two items. This may be facilitated in an embodiment of the invention by providing a three or more dimensional array of nodes. An example of a possibly relevant combination of three items may be a combination of a customer, a project and a task.

When said graphical presentation comprises items (IT) from one of said sets of items (HL) to be presented along a first direction and items (IT) from a further of said sets of items (VL) to be presented along a second direction, said two directions being mutually perpendicular, a further advantageous embodiment of the present invention has been obtained.

According to this preferred embodiment of the invention, the items of each of two sets of items are arranged in lists in different directions. Preferably, the first direction is horizontal and the second direction is vertical but any directions perpendicular to each other are within the scope of the invention.

When said graphical presentation comprises items (IT) from one of said sets of items (HL) to be presented along a first direction, items (IT) from a further of said sets of items (VL) to be presented along a second direction and items (IT) from a yet further of said sets of items (VL) to be presented along a third direction, said three directions being mutually perpendicular, a further advantageous embodiment of the present invention has been obtained.

According to this preferred embodiment of the invention, the items of each of three sets of items are arranged in lists in different directions. Preferably, the first direction is the x-axis of a three-dimensional coordinate system, the second direction the y-axis of a three-dimensional coordinate system and the third direction the z-axis of a three-dimensional coordinate system.

When said graphical presentation comprises presentation by means of a computer monitor, a further advantageous embodiment of the present invention has been obtained.

According to this preferred embodiment of the invention, the method may be performed by a computer and the user interface displayed on a monitor. A computer monitor according to the present invention may comprise CRT-monitors, TFT-monitors, etc. and may be part of a hardware environment comprising a desktop PC, a laptop PC, a PDA, etc.

When said graphical presentation comprises presentation by means of an LCD-display, a further advantageous embodiment of the present invention has been obtained.

According to this preferred embodiment of the invention, the items and nodes may be presented on an LCD-display facilitating the use of small devices, e.g. PDA's, etc.

When said time reference comprises a time period representative value, a further advantageous embodiment of the present invention has been obtained.

According to this embodiment of the invention, each time reference refers to a specific time period, e.g. 1 hour and 23 minutes. Thereby, it is possible to accumulate related period representative time references in order to calculate a total amount of time used for a certain item combination. It is, however, not possible to derive chronological times of certain events because of the lack of absolute time values.

When said time reference comprises an absolute time representative value a further advantageous embodiment of the present invention has been obtained.

According to this embodiment of the invention, each time reference comprises an absolute time, e.g. 4:42 PM. According to the invention an absolute time is the time that is measured from a certain reset point, preferably midnight. By using an absolute time value for time reference it is for each time registration possible to tell when it occurred, but not it's duration.

When said time reference comprises a date and a time, a further advantageous embodiment of the present invention has been obtained.

According to this preferred embodiment of the invention, both a date and a time are comprised by each time reference. This ensures that registrations may be e.g. chronologically sorted, even when recorded over a time span of several days.

When said one of said nodes is associated with at least two time references, a further advantageous embodiment of the present invention has been obtained.

According to this preferred embodiment of the invention, a time registration comprises two time references. These may e.g. comprise a start time and an end time of the registered event. By establishing both a start and an end value, the duration of the event may be easily calculated as the difference between the start and end times. In a further alternative, the two time references comprise a start time and a time period. Thereby, the start time and period are easily derived from the time registration and the end time may be calculated by adding the time period to the start time.

When said association is initiated by activating a node, a further advantageous embodiment of the present invention has been obtained.

According to this preferred embodiment of the invention, a node being activated initiates an association of a time reference with a node. According to the present invention such activation may comprise e.g. clicking on a node with an input device, double clicking on a node with an input device, first selecting a node and then clicking on it, selecting a node and then choosing an activate command from a menu, etc. Thereby, the initiation of a time registration may be performed with a minimum of user interaction.

When said association is completed by activating a node, a further advantageous embodiment of the present invention has been obtained.

According to this preferred embodiment of the invention, a node being activated completes an association of a time reference with a node. According to the present invention, such activation may comprise e.g. clicking on a node with an input device, double clicking on a node with an input device, first selecting a node and then clicking on it, selecting a node and then choosing an activate command from a menu, etc. Thereby, the completion of a time registration may be done with a minimum of user interaction.

When said activating a node completes an association of a node with a time reference and initiates a further association of a node with a time reference, a further advantageous embodiment of the present invention has been obtained.

According to this very preferred embodiment of the invention, the user is enabled to end one registration and immediately and automatically start another just by activating one node, e.g. by double clicking on it. This feature dramatically smoothes the process of changing between different tasks throughout a day as the time used with one task is registered and the time recording for the next task is started with e.g. just a single click with a computer mouse. And, what is more, this feature does not require additional preparation or planning as all possible combinations of items, e.g. customers and tasks, are automatically established by the graphical presentation.

When said activation is performed by a user, a further advantageous embodiment of the present invention has been obtained.

According to this preferred embodiment of the invention, a user is able to start or stop a time registration.

When said method further comprises the step of associating at least one attribute with said time registration, a further advantageous embodiment of the present invention has been obtained.

According to this preferred embodiment of the invention, an attribute may be associated with each time registration, thus enabling the time registrations to hold more information than just an item combination and a time reference. This information may e.g. serve as memorizer as a user may not be able to differentiate all time registrations just from their time reference and item combination.

The system may automatically append such an attribute, e.g. a user name, machine name, current date, etc., and/or it may let the user choose a predefined attribute, e.g. predefined comments, etc., or let the user type in the content of the attribute, e.g. a comment, etc. More attributes may be associated with each time registration.

When user-defined or user-selected content is applicable, the system may request the user to provide such content when the time registration is started, when it is ended, when it is manually registered, when it is edited, or any other time suitable. The user or system may further be able to edit an attribute at any time after it is associated with the time registration.

When said attribute comprises a comment, a further advantageous embodiment of the present invention has been obtained.

According to this preferred embodiment of the invention, the attribute is a comment, e.g. a sentence, phrase, reference number, etc. Thereby, the user or system is enabled to add further information to the time registration, e.g. to better remember their meaning or to be able to substantiate e.g. time registration based invoices, etc.

When said attribute comprises a date, a further advantageous embodiment of the present invention has been obtained.

According to this embodiment of the invention, a date is associated with the time registrations. This facilitates associations of dates that are not part of the time registrations, e.g. because of the time registrations comprising only time-of-day information, or because of a need of associating further dates with the registrations.

When said attribute comprises predefined content, a further advantageous embodiment of the present invention has been obtained.

According to this embodiment of the invention, an attribute may comprise predefined content. This predefined content may be defined by the system, a super user, the user, etc., and may e.g. comprise standard data, a companies standard invoice texts, etc., possibly in different languages.

When said attribute comprises user-defined content, a further advantageous embodiment of the present invention has been obtained.

According to this embodiment of the invention, an attribute may comprise user-defined content. This may e.g. comprise a users standard data, standard comments, standard invoice lines, tasks, etc.

When said association of at least one attribute with said time registration is mandatory, a further advantageous embodiment of the present invention has been obtained.

According to this embodiment of the invention, it is mandatory to add an attribute to each time registration.

When said association of at least one attribute with said time registration is optional, a further advantageous embodiment of the present invention has been obtained.

According to this preferred embodiment of the invention, an attribute may optionally be associated with a time registration. The decision of whether or not to add an attribute may be made by the system, the user, etc. and the decision may be requested when starting a time registration, when ending a time registration, or at any time suitable. Furthermore, the user may possibly be able to request an addition of an attribute at any time.

When said at least one time reference is established manually by a user, a further advantageous embodiment of the present invention has been obtained.

According to this embodiment of the invention, a user may manually establish a time reference and thereby a time registration. This feature may be very important in order to add registrations to the system, of events happened at places or under circumstances where live, automatic registration is impossible or e.g. due to forgetfulness of the user.

When said method further comprises the step of graphically presenting at least two further sets of items thereby establishing a further set of nodes (NO), a further advantageous embodiment of the present invention has been obtained.

According to this preferred embodiment of the present invention, more sets of nodes are established. It is noted that some or all of the at least two further sets of items may be identical to any of the at least two sets of items.

When said method further comprises the step of arranging each of said sets of nodes in different sheets, a further advantageous embodiment of the present invention has been obtained.

According to this very preferred embodiment of the invention, the different sets of nodes may be presented in different sheets, preferably overlaid each other. Thereby, a high degree of user friendliness and clarity is achieved as a user having e.g. many customers and/or tasks to manage is able to arrange these into several sheets each comprising a matrix area with nodes. According to this embodiment of the present invention, the sheets may preferably be individually named according to their subsets of items to ease the lookup of a particular item or node.

When at least one of said sheets comprises a set of nodes established on the basis of at least one automatically generated set of items and whereby said automatic generation is performed on the basis of at least one predefined criterion, a further advantageous embodiment of the present invention has been obtained.

According to this preferred embodiment of the invention, at least one of the sheets comprises a matrix which item lists are automatically generated. A preferred criterion to be used for the automatic generation of item lists is to only include the e.g. 10 most frequently used customers. Thereby, a sheet is established for quick reference to the e.g. most frequently used nodes and this sheet is preferably automatically kept up to date by the user interface.

When said at least two sets of items (HL, VL) are subsets of at least one collection of items, a further advantageous embodiment of the present invention has been obtained.

According to this embodiment of the present invention, the sets of items presented to establish the set of nodes are subsets of one or more collections of items.

When items of said at least one collection of items are arranged in a tree structure, a further advantageous embodiment of the present invention has been obtained.

According to this preferred embodiment of the present invention, the items of the collections of items are arranged in a tree structure, thereby improving user friendliness and clarity.

A further advantage of arranging the items in a tree structure is the possibility of generating a report comprising an item together with some or all underlying items.

When said at least one collection of items is user-defined, a further advantageous embodiment of the present invention has been obtained.

According to this preferred embodiment of the present invention, the user is enabled to edit the items of the collections of items including their names, comments and other attributes as well as their relations with each other that forms the tree structure.

When said at least two sets of items (HL, VL) are user-defined, a further advantageous embodiment of the present invention has been obtained.

According to this preferred embodiment of the present invention, the user is able to select from the one or more collections of items the items that should appear in each set of items and thereby be part of the establishment of nodes.

When said method further comprises the step of generating a report of time registrations, a further advantageous embodiment of the present invention has been obtained.

According to this very preferred embodiment of the invention, a report of time registrations may be established. Such a report is preferably established on paper by means of a printer but any other way of presenting a report is within the scope of the present invention, e.g. presenting it on a computer monitor, saving it to a file for later printing or viewing on a monitor, etc.

When said generation of a report facilitates filtering of time registrations, a further advantageous embodiment of the present invention has been obtained.

According to this very preferred embodiment of the invention, the time registrations to be included in a report may be filtered according to e.g. time, user, specific items, etc.

When said filtering is user-defined, a further advantageous embodiment of the present invention has been obtained.

According to this very preferred embodiment of the invention, a user may filter his or her reports preferably according to specific needs preferably at the time of generation.

When said filtering is at least partly predefined, a further advantageous embodiment of the present invention has been obtained.

According to this very preferred embodiment of the invention, a standard filtering may be automatically applied to reports generated, e.g. filtering according to user name, etc. Thereby, the user is able to generate standard reports with a minimum of interaction.

When said at least one time registration is saved to at least one database, a further advantageous embodiment of the present invention has been obtained.

According to this preferred embodiment of the invention, the time registrations are kept for future use.

When said database further comprises said collections of items, a further advantageous embodiment of the present invention has been obtained.

According to this preferred embodiment of the invention, also the collections of items are saved to the database.

When said database further comprises said sets of items, a further advantageous embodiment of the present invention has been obtained.

According to this preferred embodiment of the invention, also the sets of items are saved to the database.

When said database further comprises at least one collection of users, a further advantageous embodiment of the present invention has been obtained.

According to this preferred embodiment of the invention, a collection of users may be defined and saved to the database.

When said at least one collection of users is arranged in a tree structure, a further advantageous embodiment of the present invention has been obtained.

According to this preferred embodiment of the invention, the collection of users may reflect the actual organizational structure of e.g. the company that employs the users.

When said at least one collection of users is user defined, a further advantageous embodiment of the present invention has been obtained.

According to this preferred embodiment of the invention, the users themselves may define the user collection tree. Preferably, only specific users are allowed to edit the collection of users.

When said database is at least partly shared between at least two users, a further advantageous embodiment of the present invention has been obtained.

According to this preferred embodiment of the invention, more users may save their time registrations in the same database, see time registrations established by other users, print reports comprising other users' time registrations, etc. Preferably, it should be possible to at least partly deny other users to see, print or edit a user's registrations.

When said sharing is established by means of a computer network, a further advantageous embodiment of the present invention has been obtained.

According to this embodiment of the present invention, a computer network enables the users to share a single database. The network may be any network comprising e.g. Ethernet, Token Ring, different IBM-networks, etc., and may be driven by any network protocols, e.g. TCP/IP, IPX/SPX, etc. The networking facilities may comprise a central server, e.g. for physical storage of the database, and they may comprise authentication of users before they are allowed to use the database.

When said sharing is established by means of the Internet, a further advantageous embodiment of the present invention has been obtained.

According to this embodiment of the present invention, the Internet is used to establish connection between the users and the shared database.

When said method further facilitates resource registration, a further advantageous embodiment of the present invention has been obtained.

According to this embodiment of the invention, the method of the present invention further facilitates registration of resources rather than time references. This may e.g. comprise registration of amounts of materials, use of equipment, etc.

When said resource registration comprises resource representing items, a further advantageous embodiment of the present invention has been obtained.

According to this embodiment of the present invention, special resource representing items are used for resource registration where otherwise e.g. task items were used. Such resource representing items may e.g. comprise light bulbs, screws, wooden boards, network cables, etc.

When said resource representing items comprises resource characteristics, a further advantageous embodiment of the present invention has been obtained.

According to this embodiment of the present invention, the resource representing items comprises further information, e.g. a picture, a note, a supporting comment, a type or model number, price, etc.

When a set of resource representing nodes may be established by graphically presenting at least two sets of items, at least one of which comprises resource representing items,
thereby establishing a set of resource representing nodes,
each resource representing node representing a combination of
   a specific item from a first of said sets of items and
   a specific resource representing item from a further of said sets of items,
      a further advantageous embodiment of the present invention has been obtained.

According to this embodiment of the present invention, a set of resource representing nodes is established. Resource registration may preferably be implemented as a separate sheet having the same items, e.g. customers on the horizontal list HL, but now resources, e.g. materials or equipment, etc., on the vertical list VL.

When said resource registration may be established by associating one of said resource representing nodes with at least one amount of reference, a further advantageous embodiment of the present invention has been obtained.

According to this embodiment of the present invention, an amount reference may be associated with a resource representing node to establish a resource registration. An amount reference may e.g. comprise a number, e.g. 4 pieces, a length, e.g. 2.3 metres, a weight, e.g. 1.2 tons, etc. Preferably, when a resource representing node is activated a resource registration is made instead of a time registration by registering e.g. an amount. Thereby, the method of the present invention enables e.g. a carpenter to register material consumption or sale as well as time consumption for each e.g. customer or project.

When said at least one resource registration may be associated with said at least one time registration, a further advantageous embodiment of the present invention has been obtained.

According to this embodiment of the present invention, both a resource registration and a time registration may be established and associated with each other.

When a set of nodes established on the basis of graphically presenting at least three sets of items, at least one of which comprises resource representing items, comprises nodes each representing a combination of
a specific item from a first of said sets of items,
a specific item from a further of said sets of items,
and a specific resource representing item from a further of said sets of items,
   a further advantageous embodiment of the present invention has been obtained.

According to this preferred embodiment of the present invention, a three-dimensional matrix-area is established comprising three sets of items whereof preferably one comprises resource representing items. Thereby, the nodes established represent combinations of three specific items whereof one is a resource representing item. A probably relevant combination may comprise the combination of a customer, a task and a material. A combined time and amount registration may then be made by only selecting one node, by associating a time reference according to the task and an amount reference according to the material.

When said method is implemented by a hardware environment (HE), a further advantageous embodiment of the present invention has been obtained.

According to this preferred embodiment of the invention, the method is implemented on and performed by a hardware environment. Such environments may comprise personal computers including desktop PC's, laptop PC's, etc., portable devices PDA's, embedded systems, etc.

When said hardware environment comprises a personal computer (PC) including a central processing unit, a further advantageous embodiment of the present invention has been obtained.

According to this very preferred embodiment of the present invention, the method is performed by a personal computer system. The central processing unit CPU may be of any suitable type, e.g. an Intel x86-type, an Motorola 680×0 type, a SPARC-type, a PowerPC-type, an ARM-type, an Alpha-type, etc., or compatible types. The personal computer may be driven by any suitable operating system, e.g. Windows, MacOS, OS/2, Linux, Unix, FreeBSD, etc.

When said hardware environment (HE) further comprises data storage means, a further advantageous embodiment of the present invention has been obtained.

According to this preferred embodiment of the present invention, the hardware environment, and preferably the personal computer, comprises storage means, preferably in the form of a hard disk. Other types of storage means comprise Flash-RAM, USB-disks, floppy disks, CD-RW, tapes, etc.

Moreover saved data may be organized in any suitable form, e.g. as raw data written directly to the storage means or organized as files in a generic file system, such as e.g. FAT32, NTFS, ext2fs, etc. The access to saved data may be any suitable access method e.g. by means of direct low-level communication with the storage means controller, through file accessing methods provided by a generic operating system as e.g. Windows, Linux, etc., possibly in combination with the manufacturer of the storage means, through dedicated data accessing software such as e.g. database servers, open database connection ODBC drivers, etc. The connection to the data storage means may comprise any kind of data communication connection, e.g. parallel data buses, serial connections. USB or FireWire, local area networks, wide area networks, the Internet, wireless data connections, etc.

When said hardware environment (HE) further comprises a monitoring unit (MO), a further advantageous embodiment of the present invention has been obtained.

According to this preferred embodiment of the present invention, the hardware environment comprises a monitoring unit, e.g. a CRT-monitor, a TFT-monitor, an LCD-display, etc.

When said hardware environment (HE) further comprises activation or selecting means, a further advantageous embodiment of the present invention has been obtained.

According to this preferred embodiment of the present invention, the hardware environment comprises activating or selecting means. Preferably, these means comprise a keyboard (KB) and a computer mouse (CM), but any activation or selecting means are comprised by the invention, e.g. touch screens, touch pads, active pens, trackballs, joy sticks, etc.

When said hardware environment (HE) further comprises means for measuring at least one time period, a further advantageous embodiment of the present invention has been obtained.

According to this preferred embodiment of the invention, the hardware environment and preferably the personal computer PC measures time periods. Such time periods may have any resolution, e.g. microseconds, minutes, hours, days, etc. Practically, the maximum saveable time period often depends on the time resolution as well as the space allocated for storage. Thus, the resolution of the time measurements should be proportioned to the probable time periods.

When said hardware environment (HE) further comprises means for recording at least one absolute time, a further advantageous embodiment of the present invention has been obtained.

According to this preferred embodiment of the invention, the hardware environment, and preferably the personal computer PC, records absolute times, e.g. a task starting or ending time, etc.

Unlike a time period, an absolute time inherently comprises information of when it was recorded. Thereby, it is e.g. possible to sort a list of absolute times or a list of objects each comprising an absolute time according to their chronology. It is noted that such lists may be sorted into any data arrangement within the scope of the invention.

The present invention further relates to a time registration system comprising user interface means and time registration means wherein said user interface means comprises at least one matrix area (MA).

According to the present invention, a user interface comprising a matrix area is disclosed.

When each of said at least one matrix area (MA) comprises

at least two sets of items and

a set of nodes,

each node (NO) representing a distinct combination of one specific item (IT) from each of said at least two sets of items,
   a further advantageous embodiment of the present invention has been obtained.

According to this preferred embodiment of the invention, the matrix area comprises a set of items, e.g. arranged as a horizontal and a vertical list together with a set of nodes. The nodes represent the combinations of items from the sets of items. By selecting just one node, a number of items according to the number of sets of items are inherently selected too. Preferably, the matrix area is a rectangular area with one set of items arranged as column headers and a second set of items arranged as row headers. One node for each intersection of a row and a column is comprised by the set of nodes. Thus, a node in this preferred example represents two items, one from the column headers list and one from the row headers list.

When said time registration system further comprises means for implementing said method of establishing a time registration, a further advantageous embodiment of the present invention has been obtained.

### THE DRAWINGS

Embodiments of the present invention will in the following be described in more detail with reference to the figures of which

FIG. 1 shows a simple embodiment of a user interface of the present invention,

FIG. 2 shows an embodiment of a time registration dialog window,

FIG. 3 shows an embodiment of a user interface further comprising time totals,

FIG. 4 shows an embodiment of a user interface further comprising sheet tabs,

FIG. 5 shows an embodiment further comprising a varying content area,

FIG. 6A shows a user interface for editing an organizational tree,

FIG. 6B shows a user interface for editing customer items,

FIG. 6C shows a user interface for editing project items,

FIG. 6D shows a user interface for editing task items,

FIGS. 7 and 8 show a dialog box for selecting items to insert into the matrix area,

FIG. 9 shows a dialog box for controlling report generation, and

FIG. 10 shows a preferred hardware environment for implementation of the method of the present invention.

### DETAILED DESCRIPTION

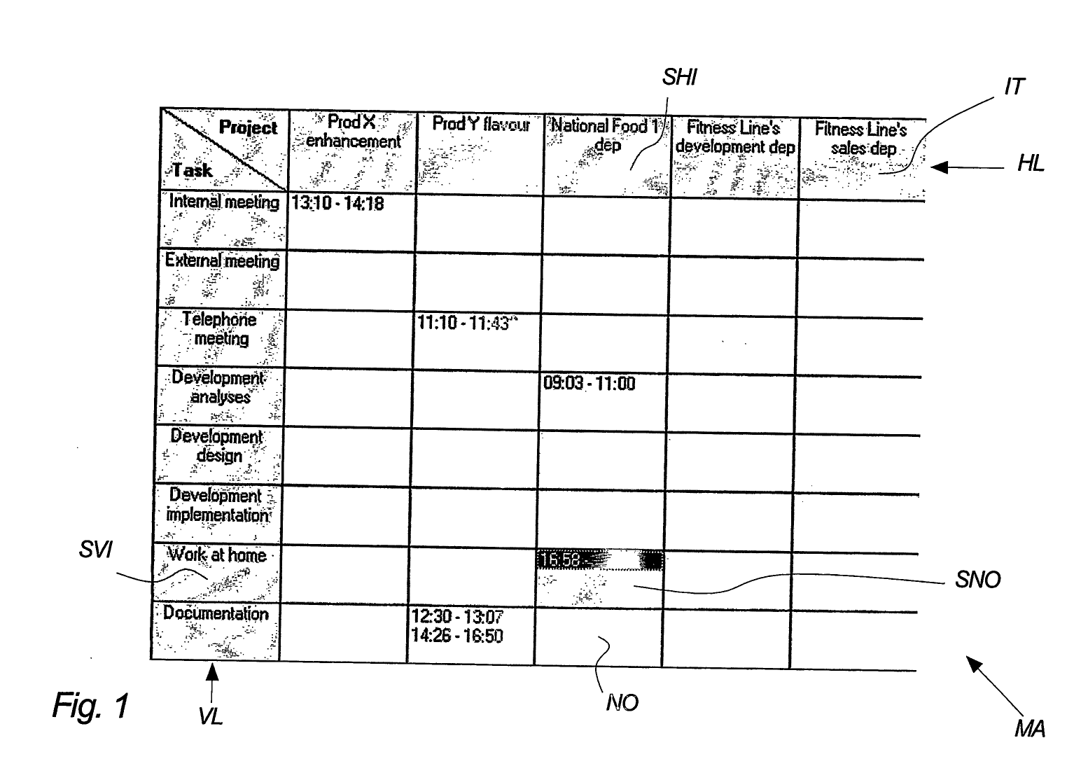

FIG. 1 shows a simple embodiment of a user interface according to the present invention. It comprises a matrix area MA that comprises a vertical list VL of items IT, a horizontal list HL of items IT and a grid of nodes NO. Each item IT in the horizontal list HL qualifies as header of a column of nodes NO and each item IT in the vertical list VL qualifies as header of a row of nodes NO. Thus, each node NO corresponds with exactly two items IT, one in the horizontal list HL and one in the vertical list VL. FIG. 1 further shows a selected node SNO that inherently qualifies an item from the horizontal list as a selected horizontal list item SHI and an item from the vertical list as a selected vertical list item SVI. In a preferred embodiment of the invention, a selected node and corresponding selected items are shown in colours that differ from the generally used colours. In alternative embodiments the selected node and items may be shown in the same colour as used elsewhere, in different colours, with different patterns or outlines, etc.

The intersection between the horizontal list HL and the vertical list VL is shown in FIG. 1 to comprise indicators of the kind of items that is comprised in the lists HL and VL. This intersection area may alternatively be empty, comprise graphics or text, e.g. a logo or a company name or trademark, helpful hints according to the application, etc.

The graphical representation of each item is in FIG. 1 shown as a text string corresponding to each item. The items may alternatively be represented with graphics, e.g. an icon or a symbol, more describing text, a combination of text and graphics, acronyms, numbers, combinations of text and numbers, etc. Furthermore, the item descriptors may be empty, thus only identified by their position, and/or they may be user-definable.

The nodes NO may graphically be shown in any suitable way. They may comprise space for showing information, e.g. text, numbers, times, etc. Preferably, a few recent time registrations, if any exists, are shown with each node NO and the current running registration, if any, is shown with only a starting time and no ending time. Also preferably a special mark is shown with registrations comprising information in addition to the standard applied information, e.g. a user comment, etc.

In FIG. 1 the two lists HL and VL are shown perpendicular to each other along straight lines, horizontal and vertical, and to the left and top of the node grid. However, any location, orientation, form, mutual displacement or rotation, etc. is within the scope of the present invention. Moreover, more than two lists are within the scope of the invention too, e.g. by establishing a three- or four-dimensional matrix.

In a preferred embodiment of the invention, a computer mouse is used for human interaction with the user interface. According to the invention, any kind of computer input device may be used comprising keyboards, trackballs, different kinds of computer input pens, touch screens, etc. Preferably, a node is selected by pointing at it with e.g. a mouse and clicking and double-clicking activate a time registration process. Alternatively, a time registration process is started when selecting a node thereby minimizing the number of required user actions. It is noted that any possible combinations of pointing, clicking, keying, etc., may be used for making selections and time registrations within the scope of the invention. Preferably, the defined actions conform to what is logical according to the operating system in use, e.g. Windows, MacOS or Unix in such a way that a user experienced with that operating system may find the actions used to interact with the user interface of the present invention intuitive and easy to memorize.

Preferably, a time registration process is ended when either a new time registration process is started, e.g. by double-clicking a different node or when the node currently being registered is double-clicked again.

Preferably, a user interface according to the present invention may comprise context menus. Such menus may be established on the display device according to a users request, e.g. by clicking with the right mouse button according to the operating system in use. A context menu displayed on behalf of a node NO may e.g. comprise menu entries for editing a registration, starting a registration, making a manual registration, etc., and a context menu displayed on behalf of an item IT may e.g. comprise menu entries for removing the item from the list, adding a new item, editing an item's properties, etc.

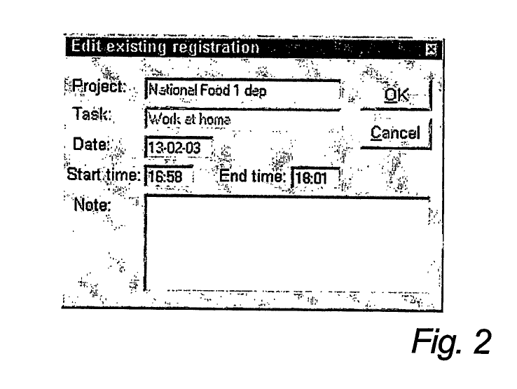

FIG. 2 shows an embodiment of a time registration dialog window. Such a window may be shown to the user when a time registration is started, when it is ended, or on request from the user, e.g. by right-clicking a time registration and choosing “Edit”.

A time registration dialog window may be used to manually adjust the starting and or ending times of that registration and to add information to the registration, e.g. additional, describing text, standard texts, things to remember, different kinds of data, etc. The user may even have the possibility to change one or more of the items comprised with the time registration or which user the time registration is assigned to.

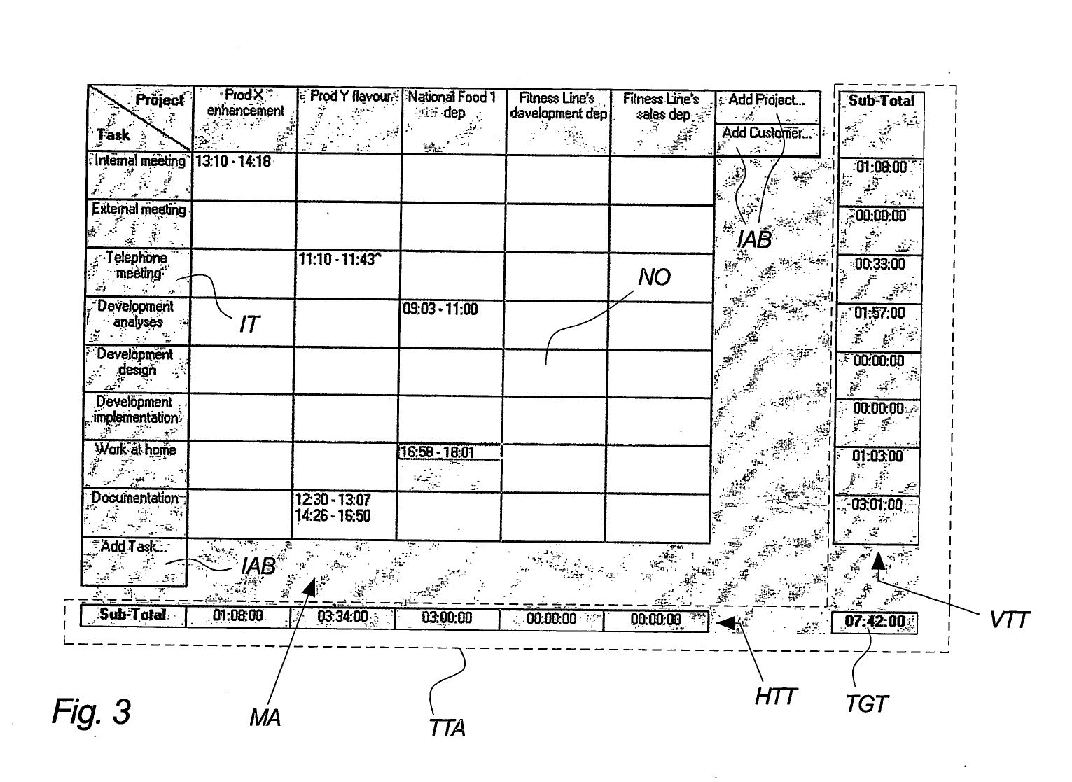

FIG. 3 shows an enhanced embodiment of a user interface of the present invention. It comprises a matrix area MA according to the description of FIG. 1 above and thereto a number of item add buttons IAB and a time totals area TTA.

The item add buttons IAB let the user request insertion of further items on the horizontal or vertical lists HL, VL. The location, appearance and caption of the buttons as shown in FIG. 3 are only exemplary embodiments and it is noted that the user interface may provide the user with any kind of means for requesting insertion of new items, including e.g. a menu entry, a button, a text-link, a keyboard shortcut, etc., or a combination of the above. It is further noted that this possibility if fully optional and the user interface therefore may not have this feature at all or only under certain circumstances, e.g. if a user with special administrator rights is logged in, the interface is in a setup and adjustment mode, etc.

The time totals area TTA, which is also fully optional, comprises a vertical list of time totals VTT and a horizontal list of time totals HTT. Furthermore, it comprises a time grand total area TGT. It is again noted that the specific appearance and functionality shown in FIG. 3 is only an exemplary implementation and that any appearance, location, orientation, specific information shown, etc., is within the scope of the present invention.

Preferably, the vertical list of time totals VTT comprises a time item for each item IT in the vertical list VL of items and the horizontal list of time total HTT comprises a time item for each item IT in the horizontal list HL of items. Thus, a time total item from the vertical list of time totals VTT represents the accumulated period of time registered with any of the nodes NO from the corresponding row of nodes and accordingly a time total item from the horizontal list of time totals HTT represents the accumulated period of time registered with any of the nodes NO from the corresponding column of nodes. The time grand total TGT represents the overall time period registered with any node, which may also be found by accumulating all vertical time total VTT values or all horizontal time total HTT.

Alternative embodiments of the invention may feature different use of the time total fields, e.g. to show a number of registrations or to show any other information, possibly but not necessarily related to time. As described above, information may be shown with each node NO within the matrix area MA, e.g. a number of recent registrations. A preferred embodiment of the invention shows all registrations established within a specified time period, preferably one day. Correspondingly, the time totals preferably show only a total time period of that specified time period, preferably one day.

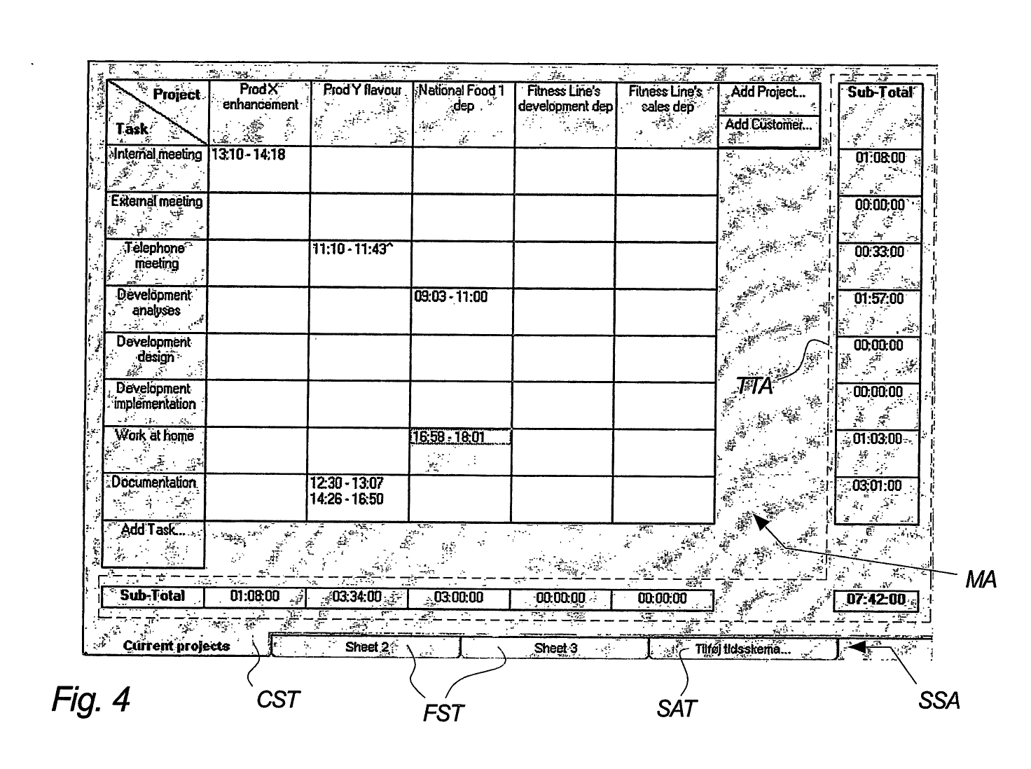

FIG. 4 shows a further enhanced embodiment of a user interface according to the present invention. It comprises a matrix area MA and a time totals area TTA as described in FIG. 3 and thereto a sheet selection area SSA.

In a preferred embodiment of the invention, more matrix areas MA are available to the user. This enables the user to arrange the items, e.g. projects and tasks, in different matrix areas according to their logical, geographical, organizational or any other relation and thereby improve clearance and order as well as generally improving the user friendliness of the application. Such numerous matrix areas may be presented to the user in different ways, including e.g. showing the areas side by side in one window, possibly with vertical and horizontal scroll bars to manage a window bigger than the viewable display area, showing each matrix area in a different window, showing all matrix areas in one window but replacing non-active matrix-areas with small icons or text, thus letting the active matrix area occupy as much viewable space as possible, etc.

FIG. 4 shows a preferred implementation of more matrix areas. Each matrix area MA optionally with accompanying time totals area TTA or other optional parts is shown in a different sheet. The sheets, which preferably are opaque, are arranged in a pile. In the sheet selection area SSA each sheet has a tab and is thereby easy to select. FIG. 4 shows three sheets with tabs in the sheet selection area SSA, a first sheet named “Current projects” having a current sheet tab CST and two further sheets named “Sheet 2” and “Sheet 3” having further sheet tabs FST. A fourth tab sheet add tab SAT is shown.

The sheet tab that appears to be topmost is denoted current sheet tab CST and it relates to the matrix area MA that is currently shown. The other sheet tabs are denoted further sheet tabs FST and appears as being placed below the current sheet tab CST. Each sheet tab may comprise some text, graphics, an icon, etc., which may refer to the related sheet. A sheet tab may e.g. comprise a name helping the user to remember what items the related matrix area comprises.

Preferably, when the user clicks on a further sheet tab FST, the current matrix area is replaced with the matrix area associated with that further sheet tab and that sheet tab becomes the new current sheet tab CST. The sheet tabs may have a context menu, e.g. displayed when the user performs a right-click on a sheet tab, comprising e.g. menu entries for renaming a sheet tab and thereby the associated matrix area, inserting a new sheet, deleting the matrix area associated with that sheet tab, etc. The sheet tabs may preferably be arranged at the user's discretion, e.g. by clicking and holding down a mouse button while the mouse pointer is moved or by another preferably common action.

The sheet add tab SAT acts as a button to let the user request the addition of a new sheet and thus a new matrix area too. This functionality may be implemented in any other suitable way, e.g. by a menu entry, a button placed elsewhere, a keyboard shortcut, a context menu entry, etc. When a new sheet is requested, the user is preferably asked for a name to relate with the new matrix area and a matrix with empty horizontal and vertical lists HL, VL is shown in the matrix area. Alternatively, a matrix area with predefined lists may be shown and/or any other predefined behaviour is initiated.

An advanced embodiment of the invention comprises a sheet with a matrix area automatically generated by the system instead of being defined by the user. Such a matrix area may comprise e.g. the seven most used items in each horizontal and vertical list to facilitate quick and easy access to the most used projects and task, both to ease starting and stopping of new registrations and to give an improved overview of a users time consumption.

In FIG. 4 the sheet selection area SSA is shown below the matrix area MA. It is noted that the sheet selection area and its appearance, location and orientation may within the scope of the present invention be implemented in any suitable way, e.g. by placing it above or on one side of the matrix area, by changing the sheet tabs to buttons, icons, texts, etc., by incorporating the sheet tabs in a menu, by adding further information to the sheet tabs, e.g. a summary of their content, etc.

It is noted that several of the graphical effects applied to improve user friendliness, including possibly the graphical representation of more sheets, may not necessarily be reflected to the code and data implementation and internal construction of the user interface as other approaches to that are probably more effective, space-saving, faster, etc.

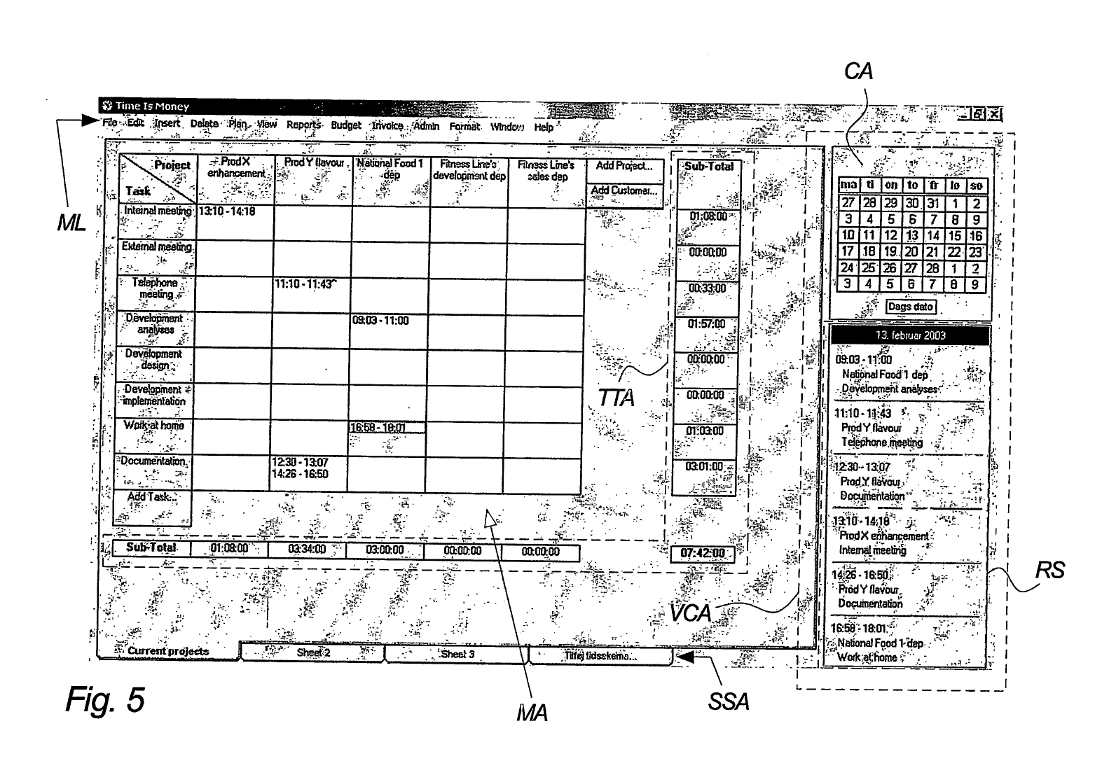

FIG. 5 shows a further improved user interface of the present invention. It comprises a matrix area MA, a time totals area TTA and a sheet selection area SSA as described above with FIGS. 1, 3 and 4. Furthermore, it comprises a menu line ML and a varying content area VCA.

The menu line ML enables the user to request an action to be performed. Each item on the menu line may in itself refer to an action or may cause a submenu to be shown. E.g. a menu item labelled “Delete” may immediately cause the deleting of an object upon activation whereas a menu item labelled “Reports” may cause a submenu comprising several different report options to be shown. Preferably, all the actions that the user interface is enabled to perform are reachable through the menu system whether or not the actions also have related buttons, tabs, context menus, etc. Some menu items may at certain times or under certain conditions be disabled, e.g. the “Insert” command may be disabled when e.g. the matrix area cannot comprise any more items, etc.

As menu lines or systems are very common within the scope of user interfaces, no further description is provided regarding the menu line ML. It is however noted that any appearance, orientation, location, etc., e.g. having icons instead of or in addition to the text, being floating, being attached to a different edge, having more lines, being user-definable, etc, of the menu line ML is within the scope of the present invention.

The varying content area VCA may be used for various purposes according to e.g. a certain state of the user interface, a user's wishes, a specific context, etc. In FIG. 5 the varying content area comprises a registration summary RS and a calendar CA. The varying content area VCA may within the scope of the present invention have any suitable appearance, location, orientation, etc.

The calendar CA may in addition to its apparent informative aim comprise functionality for e.g. choosing a date from which registrations are to be shown in the matrix area or in e.g. a registration summary RS or a report, etc. The calendar may comprise a button for going immediately to the current date. The calendar may further be shown with different time resolution, e.g. one month with one day as smallest element, one year with one month as smallest element, one week with six hours as smallest element, one day with one hour as smallest element, etc. The time resolution, the appearance, the arrangement of elements, etc, may be predefined or user-definable.

The registration summary RS comprises a list of time registrations. The list may e.g. comprise registrations made the current day, or in a specified period, either predefined or user-defined. The list may e.g. comprise registrations made on the current matrix area MA, or on any matrix area.

The information shown for each registration may be predefined or user-defined and may preferably comprise the registered time period together with the associated at least two items. In alternative embodiments more or less information may be shown, e.g. user-defined comments, information regarding the associated user, etc.

Preferably, the varying content area VCA comprises a calendar CA and a registration summary RS whenever no special action uses the area for other purposes.

It is noted that user interfaces comprising only some of the areas comprised in FIG. 5 is within the scope of the present invention. Thus, it is fully within the scope of the invention to e.g. establish a user interface comprising a matrix area MA and a varying content area VCA but not comprising a sheet selection area SSA or a time totals area TTA or any other combination of the described components and areas.

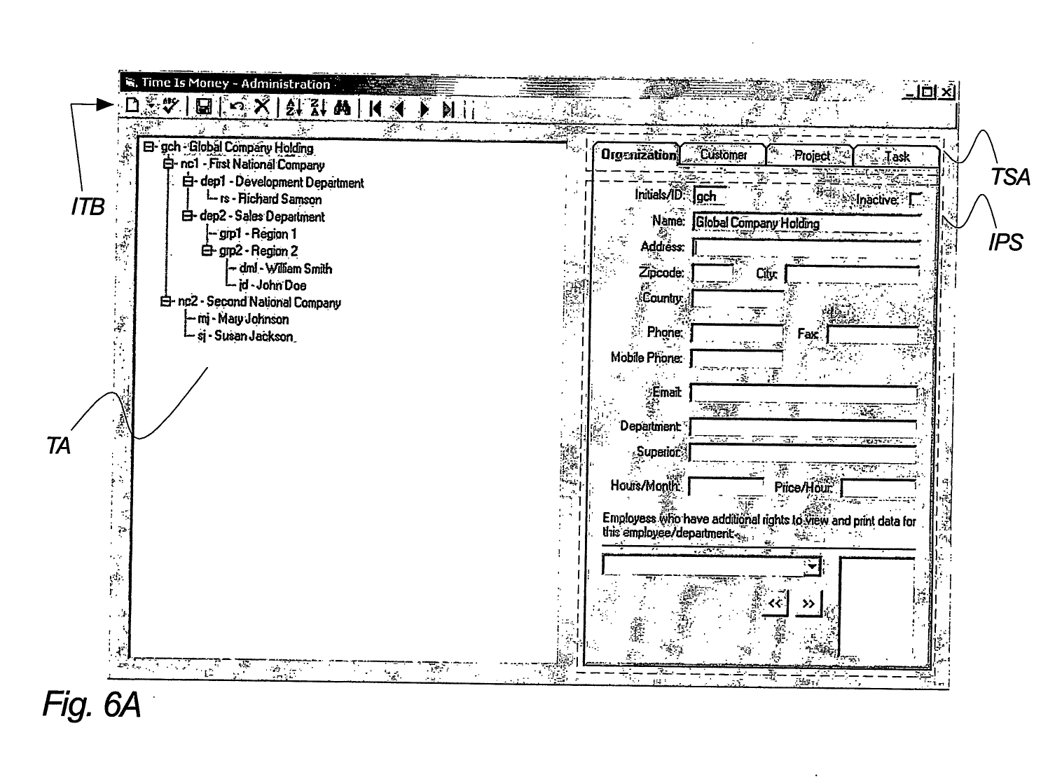

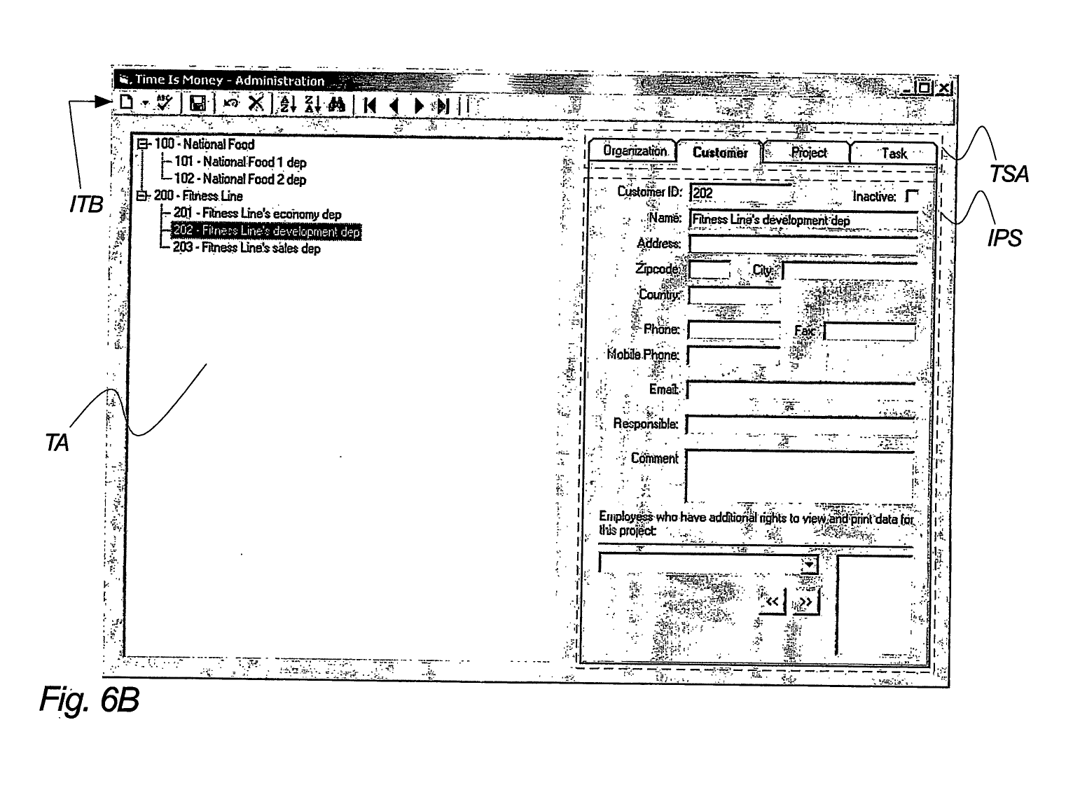

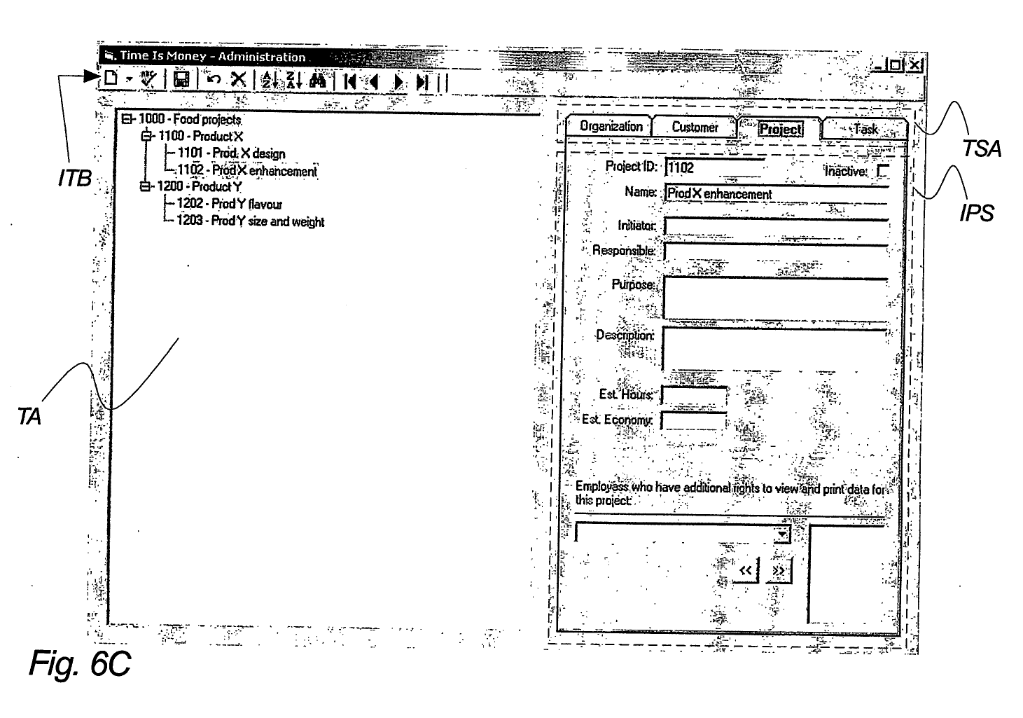

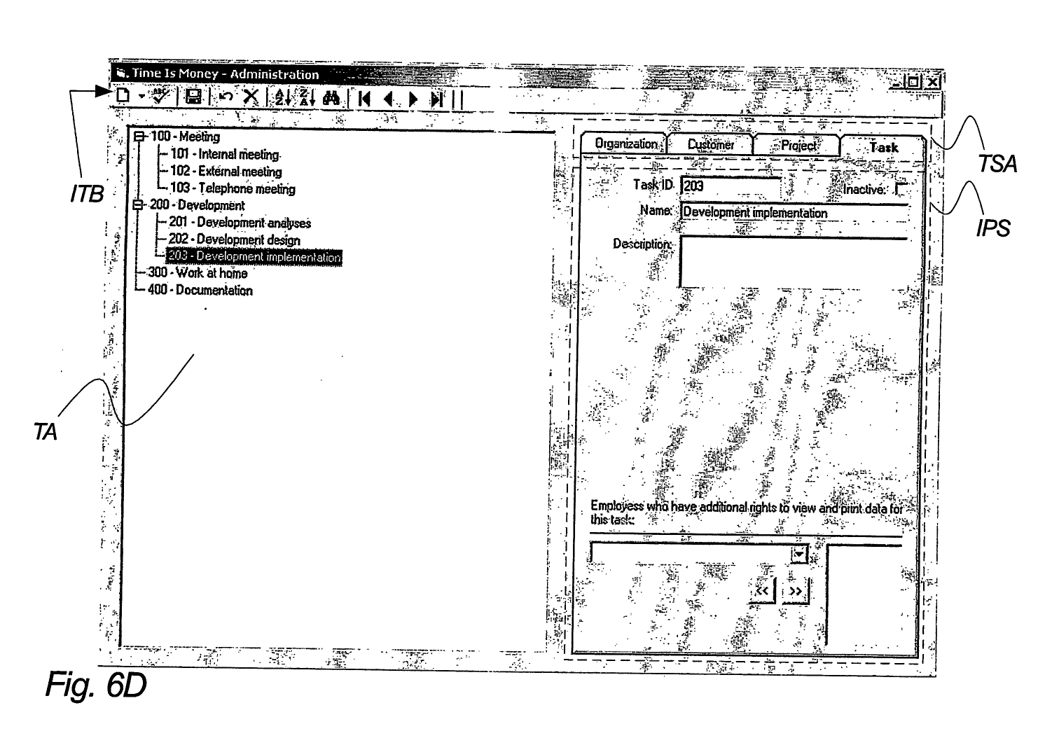

FIG. 6A-6D show four user interfaces for establishing and editing e.g. the item lists from which the items to be shown in the matrix area are chosen. It is common for all the editing features of the user interface that they may be disabled for certain users, e.g. according to predefined user rights, etc. Moreover, the implementations shown in the FIGS. 6A-6D together with the descriptions below are only implementation examples and it is noted that any suitable graphical appearance, combination of comprised features, etc. is within the scope of the present invention.

FIG. 6A shows a user interface for establishing and editing an organizational tree. This tree may e.g. comprise organizational units as e.g. companies, departments, groups, offices, employees, etc. The purpose of the tree is to enable the system to e.g. calculate the time registered for a whole department, create reports based on a specific company with all sub-units, assign a registration to a whole project group, etc. The tree should preferably comprise at least all the users that may use the system. How careful the tree have to be formed and where to put units logically belonging to several other units, e.g. a project leader also being ordinary member of a different project group, depend on which data is intended to be extracted from the system and how they should be arranged. When the system is used for only one person or a few persons in no need for extracting inter-person relational data there may be no tree at all but only a list of users.

The user interface of FIG. 6A comprises a tree selection area TSA, a tree area TA, an item property sheet IPS and an item tool bar ITB. The tree selection area TSA comprises tabs for selecting a specific tree to be shown in the tree area TA and edited in the item property sheet IPS. The embodiment in FIG. 6A shows four tabs, “Organization”, “Customer”, “Project” and “Task”. More or less tabs and different names may be pre- or user-defined according to the present invention. Each tab represents a tree or list of items. The tab chosen in FIG. 6A represents the organizational tree, which is shown in the tree area TA. It comprises an exemplary organization having daughter companies, departments and employees, etc. Each item on the tree may be selected by e.g. clicking or another kind of user interaction and the different branches may be contracted or expanded by e.g. clicking on their joints to improve clearance when working with a large tree.

The item property sheet IPS shows properties of the currently selected item from the tree. Several different details about the selected item may be filled in. The property sheet that is shown in FIG. 6A is only an exemplary implementation and any suitable or appropriate information may be added to the sheet within the scope of the present invention. In addition to plain information about an item the item property sheet may comprise system-related item information, e.g. which user may edit this item or even see it, possibly what sub-kind this item is, special information about how this item should be treated, graphics or text to be shown together with this item or used to represent this item, etc.

The item tool bar 11b comprises buttons for requesting different item specific actions, e.g. addition of a new item, deletion of an item, sorting of the items, searching for an item, etc. The toolbar shown is only an exemplary toolbar and any actions to be performed on an item, an item tree, a property sheet, etc. may be comprised on the toolbar within the scope of the present invention. Furthermore, the buttons may be represented by text, graphics, an icon, etc. The toolbar may be a so-called floating toolbar and thereby able to be placed anywhere on the user's discretion.

FIGS. 6B and 6C show user interfaces for establishing and editing a list or tree of customers and projects, respectively. As FIG. 6A they comprise an item tool bar ITB, a tree selection area TSA, a tree area TA and an item property sheet IPS. All elements function as described above regarding FIG. 6A. With the present exemplary embodiment, all items on any of these trees may be selected for use in the horizontal list HL of the matrix area of FIG. 1. A tree of customers may e.g. comprise companies, departments, employees, contacts, sales persons, purchasing managers, assignments, projects, etc. They should preferably be arranged in the tree according to their relationship with the present user. A tree of projects may e.g. comprise companies, persons, projects, sub-projects, assignments, etc. They should preferably be arranged in the tree in a way that makes most sense to the user.

The item property sheets IPS relating to the customer and project trees comprise fields for filling in additional information as the item property sheet for the organizational items.

FIG. 6D shows a user interface for establishing and editing a list or tree of tasks. As FIGS. 6A, 6B and 6C it comprises an item tool bar ITB, a tree selection area TSA, a tree area TA and an item property sheet IPS. All elements function as described above. With the present exemplary embodiment, all items in the task tree may be selected for use in the vertical list VL of the matrix area of FIG. 1. A tree of tasks may e.g. comprise task groups, tasks, task elements, actions, behaviours, etc. They should preferably be arranged in the tree as close as possible to the everyday of the user.

The item property sheet IPS relating to the task tree comprises fields for filling in additional information as the above-described property sheets.

It is noted that the four trees described above are only examples of possible trees and constitute a preferred embodiment. Any other suitable tree of items may be implemented, or there may be fewer trees. In the simplest embodiment of the invention, all items and users are arranged in only one flat list. In an advanced embodiment of the invention, each user may define their own trees according to their individual needs and/or there may be defined different trees for use in different departments, in different situations, etc.

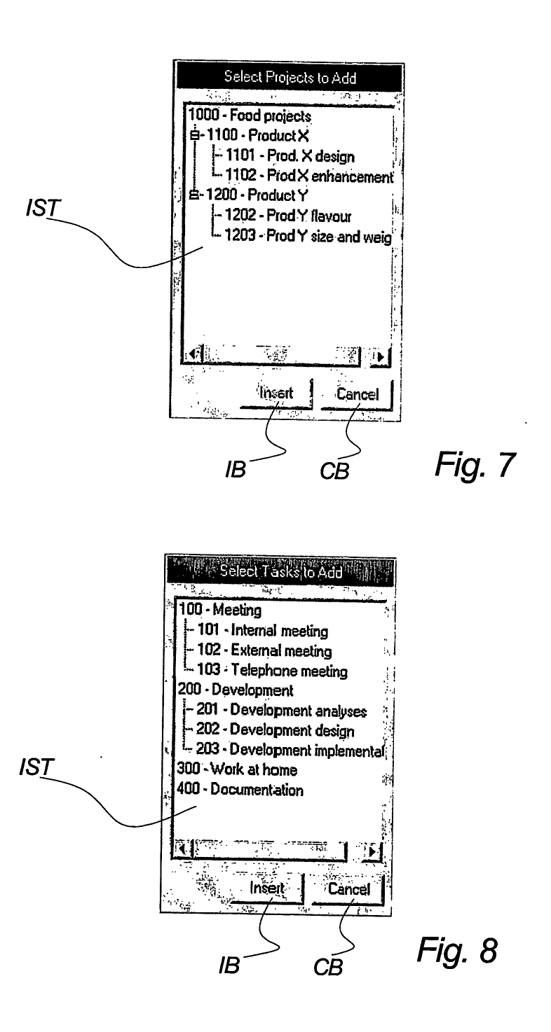

FIG. 7 shows a dialog box that is presented to the user when the user requests to insert a new item in the horizontal list HL of the matrix area of FIG. 1. It comprises an item selection tree IST, an insert button IB and a cancel button CB. In the item selection tree IST all items from a tree according to the user's request is shown, in this example the projects tree. Selecting an item on the tree and clicking the insert button IB insert that item in the horizontal list in the matrix area. Clicking the cancel button CB aborts the operation and preferably returns the user interface to a default state.

FIG. 8 shows a dialog box that is presented to the user when the user requests to insert a new item in the vertical list VL of the matrix area of FIG. 1. It comprises the same elements as FIG. 7 described above and clicking the insert button 113 causes the selected item to be inserted into the vertical list of the matrix area. The tree shown in this example is the tasks tree.

Other ways of acknowledging or requesting an insertion may be applied within the scope of the invention, e.g. to let the user “drag-and-drop” an item from the tree list to one of the lists in the matrix area.

The dialog box of FIGS. 7 and 8 is preferably shown in the varying content area VCA of FIG. 5. In an advanced embodiment of the invention, the user is able to filter, sort and search the item selection tree. Furthermore, the user may be able to select more items to insert at once. Preferably, any of the item trees in the system may be shown in this dialog box according to the user's request. It is noted that any appearance, location, orientation, etc, of the dialog box for selecting items to be inserted into the matrix area is within the scope of the invention.

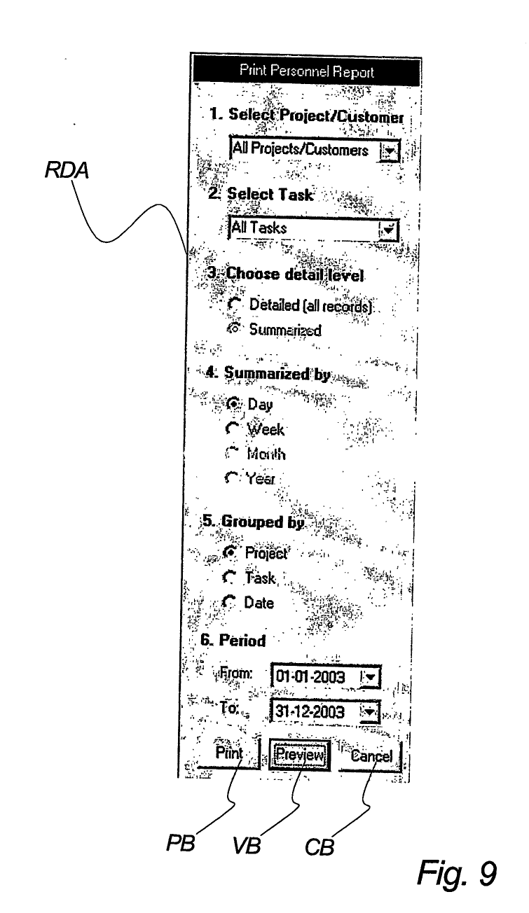

FIG. 9 shows a dialog box for controlling the generation of a report. It comprises a report defining area RDA and three buttons, a print button, PB, a preview button VB and a cancel button CB. The report defining area RDA provides facilities to sort, filter and group, etc., the data that is printed. This may comprise choice of time period, choice of sorting key, e.g. task or project, filtering options, e.g. according to customer, etc. By clicking the print button PB the report is printed, by clicking the preview button VB the report is shown in the display means preferably as it would look if printed, and by clicking the cancel button CB the operation is aborted and preferably causes the user interface to return to a default state.

The report defining dialog box shown in FIG. 9 is a simple embodiment of the print dialog. It is preferably displayed in the varying content area VCA of FIG. 5. Preferably, the simple print dialog is featured to provide the user with a very quick way to make a report and it should therefore preferably be possible to request such a simple report from several places in the user interface, e.g. from the menu line ML, from a context menu, from a command button, etc. The simple report dialog may preferably have several parameters predefined, such as for which user the report should include data, the look of the report, how much information for each registration should be included, etc.

The user interface may in addition preferably feature a more advanced print dialog box enabling the user to take control over all report generation parameters.

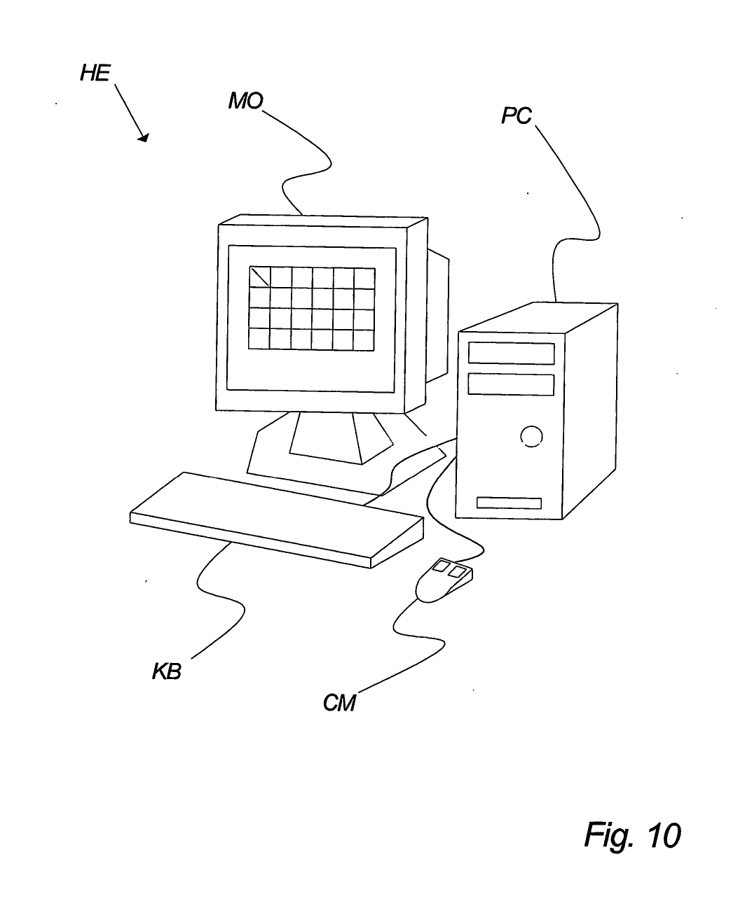

FIG. 10 shows a preferred hardware environment for implementation of the method and system of the present invention, preferably the above-described user interface. It comprises a personal computer PC including a CPU (not shown) the said computer PC comprising a data disk and an arithmetic logic circuit configured to prepare the data disk to magnetically store selected data (not shown).

The computer moreover comprises a monitoring unit MO and activation or selecting means in the form of a keyboard KB and a computer mouse CM.

1. Method of establishing a time registration comprising the steps of graphically presenting at least two sets of items (HL, VL), thereby establishing a set of nodes (NO), each node (NO) representing a combination of a specific item (IT) from a first of said sets of items (HL) and a specific item (IT) from a further of said sets of items (VL); and associating one of said nodes (NO) with at least one time reference.

2. Method of establishing a time registration according to claim 1, whereby said combination of a specific item (IT) from a first of said sets of items (HL) and a specific item (IT) from a further of said sets of items (VL) is further combined with at least one further specific item (IT) from at least one of said sets of items.

3. Method of establishing a time registration according to claim 1, whereby said graphical presentation comprises items (IT) from one of said sets of items (HL) to be presented along a first direction and items (IT) from a further of said sets of items (VL) to be presented along a second direction, said two directions being mutually perpendicular.

4. Method of establishing a time registration according to claim 1, whereby said graphical presentation comprises items (IT) from one of said sets of items (HL) to be presented along a first direction, items (IT) from a further of said sets of items (VL) to be presented along a second direction and items (IT) from a yet further of said sets of items (VL) to be presented along a third direction, said three directions being mutually perpendicular.

5. Method of establishing a time registration according to claim 1, whereby said graphical presentation comprises presentation by means of a computer monitor.

6. Method of establishing a time registration according to claim 1, whereby said graphical presentation comprises presentation by means of an LCD-display.

7. Method of establishing a time registration according to claim 1, whereby said time reference comprises a time period representative value.

8. Method of establishing a time registration according to claim 1, whereby said time reference comprises an absolute time representative value.

9. Method of establishing a time registration according to claims 1, whereby said time reference comprises a date and a time.

10. Method of establishing a time registration according to claim 1, whereby said one of said nodes is associated with at least two time references.

11. Method of establishing a time registration according to claim 1, whereby said association is initiated by activating a node.

12. Method of establishing a time registration according to claim 11, whereby said association is completed by activating a node.

13. Method of establishing a time registration according to claim 11, whereby said activating of a node completes an association of a node with a time reference and initiates a further association of a node with a time reference.

14. Method of establishing a time registration according to claim 11, whereby said activation is performed by a user.

15. Method of establishing a time registration according to claim 1, whereby said method further comprises the step of associating at least one attribute with said time registration.

16. Method of establishing a time registration according to claim 15, whereby said attribute comprises a comment.

17. Method of establishing a time registration according to claim 15, whereby said attribute comprises a date.

18. Method of establishing a time registration according to claim 15, whereby said attribute comprises predefined content.

19. Method of establishing a time registration according to claim 15, whereby said attribute comprises user-defined content.

20. Method of establishing a time according to claim 15, whereby said association of at least one attribute with said time registration is mandatory.

21. Method of establishing a time registration according to claim 15, whereby said association of at least one attribute with said time registration is optional.

22. Method of establishing a time registration according to claims 1, whereby said at least one time reference is established manually by a user.

23. Method of establishing a time registration according to claims 1, whereby said method further comprises graphically presenting at least two further sets of items thereby establishing a further set of nodes (NO).

24. Method of establishing a time registration according to claim 23, whereby said method further comprises arranging each of said sets of nodes in different sheets.

25. Method of establishing a time registration according to claim 24, whereby at least one of said sheets comprises a set of nodes established on a basis of at least one automatically generated set of items, and whereby said automatic generation is performed on a basis of at least one predefined criterion.

26. Method of establishing a time registration according to claim 1, whereby said at least two sets of items (HL, VL) are subsets of at least one collection of items.

27. Method of establishing a time registration according to claim 26, whereby items of said at least one collection of items are arranged in a tree structure.

28. Method of establishing a time registration according to claim 26, whereby said at least one collection of items is user-defined.

29. Method of establishing a time registration according to claim 1, whereby said at least two sets of items (HL, VL) are user-defined.

30. Method of establishing a time registration according to claim 1, whereby said method further comprises the step of generating a report of time registrations.

31. Method of establishing a time registration according to claim 30, whereby said generation of a report facilitates filtering of time registrations.

32. Method of establishing a time registration according to claim 31, whereby said filtering is user-defined.

33. Method of establishing a time registration according to claim 33, whereby said filtering is at least partly predefined.

34. Method of establishing a time registration according to claim 30, whereby said at least one time registration is saved to at least one database.

35. Method of establishing a time registration according to claim 34, whereby said database further comprises said collections of items.

36. Method of establishing a time registration according to claim 35, whereby said database further comprises said sets of items.

37. Method of establishing a time registration according to claim 35, whereby said database further comprises at least one collection of users.

38. Method of establishing a time registration according to claims 37, whereby said at least one collection of users is arranged in a tree structure.

39. Method of establishing a time registration according to claim 37, whereby said at least one collection of users is user defined.

40. Method of establishing a time registration according to claims 34, whereby said database is at least partly shared between at least two users.

41. Method of establishing a time registration according to claim 40, whereby said sharing is established by means of a computer network.

42. Method of establishing a time registration according to claim 40, whereby said sharing is established by means of the Internet.

43. Method of establishing a time registration according to claim 1, whereby said method further facilitates resource registration.

44. Method of establishing a time registration according to claim 43, whereby said resource registration comprises resource representing items.

45. Method of establishing a time registration according to claim 44, whereby said resource representing items comprises resource characteristics.

46. Method of establishing a time registration according to claim 1, whereby a set of resource representing nodes may be established by graphically presenting at least two sets of items, at least one of which comprises resource representing items, thereby establishing a set of resource representing nodes, each resource representing node representing a combination of a specific item from a first of said sets of items and a specific resource representing item from a further of said sets of items.

47. Method of establishing a time registration according to claim 46, whereby said resource registration may be established by associating one of said resource representing nodes with at least one amount reference.

48. Method of establishing a time registration according to claim 46, whereby said at least one resource registration may be associated with said at least one time registration.

49. Method of establishing a time registration according to claim 1, whereby a set of nodes established on the basis of graphically presenting at least three sets of items, at least one of which comprises resource representing items, comprises nodes each representing a combination of a specific item from a first of said sets of items, a specific item from a further of said sets of items and a specific resource representing item from a further of said sets of items.

50. Method of establishing a time registration according to claim 1, whereby said method is implemented by a hardware environment (HE).

51. Method of establishing a time registration according to claim 50, whereby said hardware environment comprises a personal computer (PC) including a central processing unit.

52. Method of establishing a time registration according to claim 50, whereby said hardware environment (HE) further comprises data storage means.

53. Method of establishing a time registration according to claim 50, whereby said hardware environment (HE) further comprises a monitoring unit (MO).

54. Method of establishing a time registration according to claim 50, whereby said hardware environment (HE) further comprises activation or selecting means.

55. Method of establishing a time registration according to claim 50, whereby said hardware environment (HE) further comprises means for measuring at least one time period.

56. Method of establishing a time registration according to claims 50, whereby said hardware environment (HE) further comprises means for recording at least one absolute time.

57. A time registration system comprising user interface means and time registration means, wherein said user interface means comprises at least one matrix area (MA).

58. A time registration system according to claim 57, wherein each of said at least one matrix area (MA) comprises at least two sets of items and a set of nodes, each node (NO) representing a distinct combination of one specific item (IT) from each of said at least two sets of items.

59. A time registration system according to claim 57, further comprising means for graphically presenting at least two sets of items (HL VL), thereby establishing a set of nodes (NO), each node (NO) representing a combination of a specific item (IT) from a first of said sets of items (HL) and a specific item (IT) from a further of said sets of items (VL); and associating one of said nodes (NO) with at least one time reference.
